(19) United States
(12) Patent Application Publication
(10) Pub. No.: US 2025/0109730 A1
(43) Pub. Date: Apr. 3, 2025

(54) METHOD AND SYSTEM FOR MONITORING OPERATION OF HYDRAULIC TURBINE UNDER EXTREMELY LOW WATER HEAD

(71) Applicant: China Energy Science and Technology Research Institute Co., Ltd., Nanjing (CN)

(72) Inventors: Zhile Jiang, Nanjing (CN); Kunlong Song, Nanjing (CN); Ruiji Yi, Nanjing (CN); Yufeng Hu, Nanjing (CN); Pan Liu, Nanjing (CN); Jun Lu, Nanjing (CN); Yingli Wu, Nanjing (CN); Qiming Zhong, Nanjing (CN); Denghua Li, Nanjing (CN); Jiang Yu, Nanjing (CN); Wanli Guo, Nanjing (CN); Honglei Ren, Nanjing (CN)

(21) Appl. No.: 18/900,510

(22) Filed: Sep. 27, 2024

(30) Foreign Application Priority Data
Sep. 28, 2023 (CN) 202311272325.0

(51) Int. Cl. F03B 11/00; F03B 17/06

(52) U.S. Cl. CPC F03B 11/008; F03B 17/06

(57) ABSTRACT

A method and system for monitoring operation of a hydraulic turbine under an extremely low water head, belonging to the technical field of hydraulic turbines. The method includes: acquiring static operating parameters of a target hydraulic turbine; determining an operating limit water level of the target hydraulic turbine based on the static operating parameters; determining dynamic operating parameters of the target hydraulic turbine, and simulating operating conditions of the hydraulic turbine based on the static operating parameters and the dynamic operating parameters; dividing operating condition regions of the hydraulic turbine based on the simulated operating conditions of the hydraulic turbine to obtain an operating condition division result; determining monitored operating condition regions of the target hydraulic turbine based on the operating limit water level and the operating condition division result; and monitoring real-time operating conditions of the target hydraulic turbine based on the monitored operating condition regions. The method and system solve the problem that the operating state of hydraulic turbines under an extremely low water head cannot be accurately monitored.

### RELATED APPLICATIONS

This application claims the priority of Chinese Application No. 202311272325.0, filed on Sep. 28, 2024, entitled “METHOD AND SYSTEM FOR MONITORING OPERATION OF HYDRAULIC TURBINE UNDER EXTREMELY LOW WATER HEAD”, which is incorporated herein in its entirety for all purposes.

### FIELD OF THE INVENTION

The present disclosure relates to the technical field of hydraulic turbines, in particular to a method for monitoring operation of a hydraulic turbine under an extremely low water head and a system for monitoring operation of a hydraulic turbine under an extremely low water head.

### BACKGROUND OF THE INVENTION

In the design of a hydropower station, according to sediment accumulation, the layout of hydraulic structures, and the like, a fluctuation depth of a water level of a reservoir is set, and the lowest water level is a dead water level of the reservoir. During normal operation, operation below the dead water level is not allowed in principle. However, during actual operation, operation below the dead water level (i.e., operation under an extremely low water head) is an abnormal operation mode, but it is unavoidable. First, in the case of insufficient incoming water, due to the needs of downstream industrial and agricultural water, in order to avoid greater loss of abandoned water, when a water level of the reservoir fluctuates below the dead water level, a hydraulic turbine has to operate under the extremely low water head; second, in extreme cases, as an emergency reserve capacity, a hydraulic turbine set needs to operate continuously to ensure power supply, and the water level of the reservoir is highly likely to drop below the dead water level; and third, when a reservoir capacity needs to be vacated for construction or maintenance in a reservoir area, operation is performed under the extremely low water head in order to avoid water abandonment. In addition, some cascade power stations in river basins are constructed earlier, which fails to make full use of the advantages of cascade dispatching in the river basins, thereby requiring optimization of existing reservoir scheduling. On the premise of meeting the submersion depth of a water inlet, a restraining factor limiting the operation below the dead water level is mainly a hydraulic turbine, and the corresponding water head operating conditions under the dead water level is often less than a minimum water head of the hydraulic turbine, and the simulation and test in this water head area are essentially blank whether model tests or real hydraulic turbine tests. In view of this problem, it is necessary to create a technical solution for accurately monitoring the operating state of the hydraulic turbine set under the extremely low water head.

### SUMMARY OF THE INVENTION

An object of the embodiments of the present disclosure is to provide a method and system for monitoring operation of a hydraulic turbine under an extremely low water head to at least solve the problem that the operating state of hydraulic turbines under an extremely low water head cannot be accurately monitored in the existing solutions.

In order to achieve the above object, in a first aspect of the present disclosure, provided is a method for monitoring operation of a hydraulic turbine under an extremely low water head, including: acquiring static operating parameters of a target hydraulic turbine, and determining an operating limit water level of the target hydraulic turbine based on the static operating parameters; determining dynamic operating parameters of the target hydraulic turbine, and simulating operating conditions of the hydraulic turbine based on the static operating parameters and the dynamic operating parameters; dividing operating condition regions of the hydraulic turbine based on the simulated operating conditions of the hydraulic turbine to obtain an operating condition division result; and determining monitored operating condition regions of the target hydraulic turbine based on the operating limit water level and the operating condition division result, and monitoring real-time operating conditions of the target hydraulic turbine based on the monitored operating condition regions.

In a second aspect of the present disclosure, provided is a system for monitoring operation of a hydraulic turbine under an extremely low water head based on the simulated operating conditions of the hydraulic turbine, the system including: an acquiring unit, configured to acquire static operating parameters of a target hydraulic turbine, and determine an operating limit water level of the target hydraulic turbine based on the static operating parameters; a simulation unit, configured to determine dynamic operating parameters of the target hydraulic turbine, and simulate operating conditions of the hydraulic turbine based on the static operating parameters and the dynamic operating parameters; a dividing unit, configured to divide operating condition regions of the hydraulic turbine based on the simulated operating conditions of the hydraulic turbine to obtain an operating condition division result; and a monitoring unit, configured to determine monitored operating condition regions of the target hydraulic turbine based on the operating limit water level and the operating condition division result, and monitor real-time operating conditions of the target hydraulic turbine based on the monitored operating condition regions.

In another aspect, a third aspect of the present disclosure provides a computer-readable storage medium having stored thereon instructions that, when run on a computer, cause the computer to perform the method for monitoring operation of a hydraulic turbine under an extremely low water head described above.

In another aspect, a fourth aspect of the present disclosure provides a device, including: a memory storing a program capable of running on a processor; and the processor. The processor is configured to implement the following steps when executing the program: acquiring static operating parameters of a target hydraulic turbine, and determining an operating limit water level of the target hydraulic turbine based on the static operating parameters; determining dynamic operating parameters of the target hydraulic turbine, and simulating operating conditions of the hydraulic turbine based on the static operating parameters and the dynamic operating parameters; dividing operating condition regions of the hydraulic turbine based on the simulated operating conditions of the hydraulic turbine to obtain an operating condition division result; and determining monitored operating condition regions of the target hydraulic turbine based on the operating limit water level and the operating condition division result, and monitoring real-time operating conditions of the target hydraulic turbine based on the monitored operating condition regions.

Through the above technical solutions, the solution of the present disclosure proposes a method for accurately dividing operating regions under an extremely low water head, and since the extremely low water head is an extreme operating condition, the solution of the present disclosure proposes a “prediction+verification” idea to perform the division of the operating regions. “Prediction” is to preliminarily fit the operating regions by using model tests and normal water head data that have been developed, and “verification” is to compare and analyze one or two extremely low water heads measured with those in the “predicted” regions to further optimize the operating regions, make it closer to the real situation.

Additional features and advantages of the embodiments of the present disclosure will be described in detail in the subsequent Detailed Description.

### BRIEF DESCRIPTION OF DRAWINGS

The accompanying drawings are used to provide a further understanding of the embodiments of the present disclosure and constitute a part of this specification, and together with the detailed description below serve to explain, but not to limit, the embodiments of the present disclosure. In the accompanying drawings:

FIG. 1 is a flow chart showing the steps of a method for monitoring operation of a hydraulic turbine under an extremely low water head according to an embodiment of the present disclosure;

FIG. 2 is a schematic diagram showing one operating region division result according to an embodiment of the present disclosure;

FIG. 3 is a schematic diagram showing another operating region division result according to an embodiment of the present disclosure; and

FIG. 4 is a structural diagram of a system for monitoring operation of a hydraulic turbine under an extremely low water head according to an embodiment of the present disclosure.

### DETAILED DESCRIPTION OF THE EMBODIMENTS

Specific embodiments of the present disclosure will be described below with reference to the accompanying drawings. It should be understood that the specific embodiments described herein are merely illustrative and explanatory of the present disclosure, and are not intended to limit the present disclosure.

In general, a dead water level of a reservoir is the lowest water level at which power generation enterprises operate, and hydraulic turbines do not operate below the dead water level. Therefore, the prior art lacks systematic explanation and specific operation methods of operation below the dead water level. When actually encountering extreme situations that require operation under extremely low water heads, a method of “uninterrupted monitoring+manual judgment” is often adopted for scheduling, lacking a scientific and reasonable operation scheduling strategy. In power stations with “unmanned on duty and few people on duty”, it is more likely to directly abandon the emergency reserve capacity.

In addition, due to the lack of data on operation under an extremely low water head, the related technical measures are currently mainly elucidated at low water levels close to the dead water level, mainly including the following three elucidation solutions:
a first elucidation solution is to divide load areas by directly using model data, but due to dimensional deviations of a hydraulic turbine model from a real hydraulic turbine, there is a large deviation between the fitted load area and the actual load area.
a second elucidation solution is to entrust an external testing agency to perform real hydraulic turbine testing. Compared with the first elucidation solution, data is more realistic, but due to the limitation of testing conditions, only intermittent operating condition points can be collected. The fitted load area tends to be rough, and even abnormalities in some operating conditions cannot be identified, causing harm to the operation of a hydraulic turbine set.
a third elucidation solution is to use an online condition monitoring system to monitor a full load area of the hydraulic turbine under all operating conditions and divide the loads according to established health discrimination criteria to guide operation. However, firstly, this solution is greatly affected by test points and is not as comprehensive as offline test points in the second solution, secondly, the health discrimination criteria are heavily influenced by human factors and lack scientificity, and thirdly, the discrimination criteria only have amplitude judgment, which cannot respond in time to specific working conditions that may cause abnormal hazards.

Therefore, in view of the problem that the operating state of hydraulic turbines under an extremely low water head cannot be accurately monitored in the existing solutions, an embodiment of the present disclosure proposes a method for monitoring operation of a hydraulic turbine under an extremely low water head, and the method proposes a solution for accurately dividing operating regions under an extremely low water head, and since the extremely low water head is an extreme operating condition, the embodiment of the present disclosure proposes a “prediction+verification” idea to perform the division of the operating regions. “Prediction” is to preliminarily fit the operating regions by using model tests and normal water head data that have been developed, and “verification” is to compare and analyze one or two extremely low water heads measured with those in the “predicted” regions to further optimize the operating regions, make it closer to the real situation.

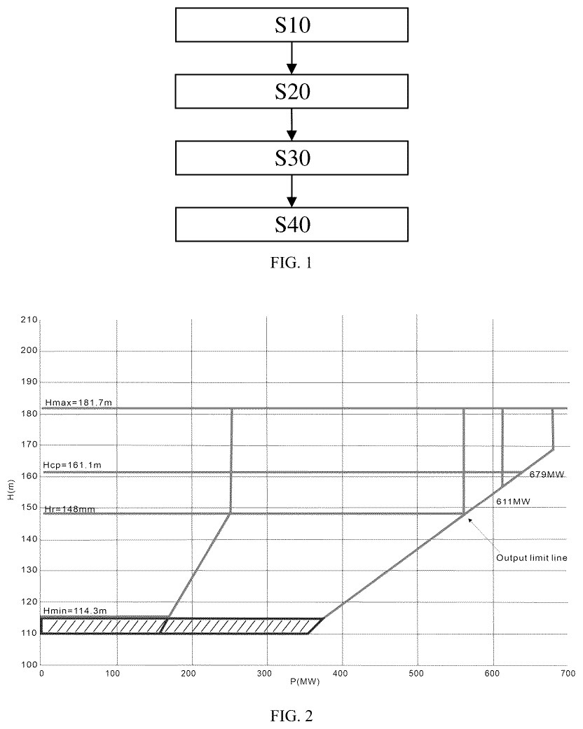

FIG. 1 is a flow chart of a method for monitoring operation of a hydraulic turbine under an extremely low water head according to an embodiment of the present disclosure, and the method is executed, for example, by a computer. As shown in FIG. 1, the method includes the following steps S10-S40.

Step S10: acquiring static operating parameters of a target hydraulic turbine, and determining an operating limit water level of the target hydraulic turbine based on the static operating parameters.

In particular, by identifying key operating parameters of the hydraulic turbine and determining health standards, this solution implements multiple measures at the same time to accurately divide extremely low water head operating regions, which can optimize the operation mode of hydraulic turbines under the extremely low head, achieving the state sensing and intelligent early warning of key components during the over-limit operation of the hydraulic turbine from both safety and economy perspectives, and constructing an evaluation system for the operation of the hydraulic turbine under the extremely low head, thereby achieving the purpose of guiding the dispatching operation of the hydraulic turbine under the extremely low head, increasing the emergency reserve capacity of hydropower enterprises, and improving economic benefits.

Further, the static operating parameters include one or more of a hydraulic turbine set type, a reservoir dead water level, a water inlet layout elevation, a normal tail water level, a hydraulic turbine operating performance curve, hydraulic turbine model test data, hydraulic turbine set online monitoring data, a water supply mode, a gate hole height, a cross-section average flow rate in a gate hole, and a water inlet top elevation.

In one possible embodiment, the computer searches, for example, data of the hydraulic turbine and a power station stored in a designated database, the data including but not limited to: the hydraulic turbine set type, the reservoir dead water level, the water inlet layout elevation, the normal tail water level, a hydraulic turbine comprehensive operating performance curve, a hydraulic turbine model test report, arrangement of test points of a hydraulic turbine set online condition monitoring system, a technical water supply mode, and the like.

Further, operation under the extremely low water head has a significant impact on hydraulic turbines. Firstly, output limits corresponding to the water heads are inconsistent, and a slight carelessness may cause flow separation. Therefore, the output limit line needs to be determined by a full water head vibration zone test. And secondly, due to further deviation from the optimal operating conditions, the operable region of the hydraulic turbine is narrow, and abnormal pressure fluctuation and vibration induced by unstable hydraulic factors are elusive, and improper operation scheduling poses great harm to the hydraulic turbine. The water head of the hydraulic turbine corresponds to the reservoir water level of a hydropower station. Generally, when the reservoir water level is low, the water head of the hydraulic turbine is also low. For the hydraulic structures of the hydropower station, there is a certain limit to the fluctuation of the reservoir water level, where the most important prerequisite is that the lowest reservoir water level should absolutely avoid hydraulic oscillations caused by air inlet of a water inlet. Therefore, when operating below the dead water level (at this time, the hydraulic turbine has an extremely low water head), the maximum fluctuation depth of the reservoir water level should be considered first, that is, the lowest operable reservoir water level, i.e., the operating limit water level Hₘᵢₙ, is determined.

Preferably, for the step S10, determining the operating limit water level of the target hydraulic turbine based on the static operating parameters includes: calculating a minimum submersion depth based on the static operating parameters and a preset first calculation model; and calculating the operating limit water level based on the minimum submersion depth and a preset second calculation model.

In particular, the first calculation model is:

S=Cvd^{0.5}
wherein S is the minimum submersion depth, C is a preset factor, taking 0.55 for a symmetric water flow and 0.73 for other water flows; v is a cross-section average flow rate in a gate hole, and dis a gate hole height;
the second calculation model is:

$${H}_{min} = {H}_{d} + S$$

wherein H_{d} is a water inlet top elevation, and Hₘᵢₙ is the operating limit water level.

Step S20: determining dynamic operating parameters of the target hydraulic turbine, and simulating operating conditions of the hydraulic turbine based on the static operating parameters and the dynamic operating parameters.

In particular, the dynamic operating parameters include one or more of pressure fluctuation in a draft tube, pressure fluctuation in a bladeless region, head cover vibration, and a hydraulic turbine guide bearing run-out.

In one possible embodiment, with reference to the operation of the hydraulic turbine under other water levels, the operating parameters that respond most closely to changes in water head and load are selected. Taking the most commonly used mixed-flow hydraulic turbine as an example, the key operating parameters are the pressure fluctuation in a draft tube, the pressure fluctuation in a bladeless region, the head cover vibration, and the hydraulic turbine guide bearing run-out.

### Example 1

Simulating the operating conditions of the hydraulic turbine based on the static operating parameters and the dynamic operating parameters includes: traversing all water heads, and simulating the operating conditions of the hydraulic turbine based on an electrical measurement method under the water heads; separately collecting operating parameters of the hydraulic turbine corresponding to simulation results under the water heads as simulation parameters; and integrating the simulation parameters under all the water heads to form a simulation parameter set.

Specifically, the full water head vibration zone test of the hydraulic turbine is to collect and record stability parameters such as vibration, runout, pressure fluctuation and noise which are related to the hydraulic turbine under different water heads and loads by the electrical measurement method, analyze the effect of hydraulic factors on a vibration zone of the hydraulic turbine under various operating conditions, determine possible vibration load areas caused by abnormal hydraulic factors such as a vortex band in a draft tube, a Karman vortex and a channel vortex, establish the health standards for the operation of the hydraulic turbine, and divide the operation regions of the hydraulic turbine under full water heads accordingly as an important technical basis for scheduling and safe operation.

### Example 2

Simulating the operating conditions of the hydraulic turbine based on the static operating parameters and the dynamic operating parameters includes: collecting standard information for hydraulic turbine operation based on an open standard knowledge base; traversing preset operating conditions, and determining threshold values of the parameters based on the standard information for hydraulic turbine operation; and obtaining a set of the threshold values based on all the threshold values.

In particular, the health standards for the hydraulic turbine guide bearing run-out and head cover vibration are determined according to national and industry standards and regulations (which can be appropriately increased but not decreased); for the health standard determination of pressure fluctuation, the determination is made from the amplitude and frequency spectrum, respectively, the amplitude should not exceed 3-11% h (h is the operating water head of the hydraulic turbine), and the frequency spectrum features should not have significant resonance phenomena.

Therefore, through Example 1 and Example 2, a method for determining a health status of the hydraulic turbine under extremely low water head operating conditions in the embodiments of the present disclosure is different from other similar methods in the prior art in that: 1) the method is diverse, and in addition to the validated health standards, other methods can also be used; and 2) not limited to amplitude determination, the frequency spectrum is also a representation of some harsh operating conditions, so the frequency spectrum is also used as a determination condition.

Step S30: dividing operating condition regions of the hydraulic turbine based on the simulated operating conditions of the hydraulic turbine.

Specifically, a two-dimensional coordinate system is constructed with a hydraulic turbine set load as an abscissa and a water head height as an ordinate; a curve is generated in the two-dimensional coordinate system based on the simulation parameter set or the set of the threshold values; and the operating condition regions are divided based on a preset operating condition division parameter interval for the generated curve. Wherein the operating condition regions include a low-efficiency operating condition region, a vortex band operating condition region, and a stable operating condition region.

As shown in FIG. 2, in one possible embodiment, the curve is generated based on the simulation parameter set, it can be seen that a minimum operating water head Hₘᵢₙ of the hydraulic turbine is 114.3 m, but a minimum water head in a model test reaches 110 m, and in the interval 110 m to 114.3 m (a trapezoidal box area), a load region can be preliminarily defined by using model test data.

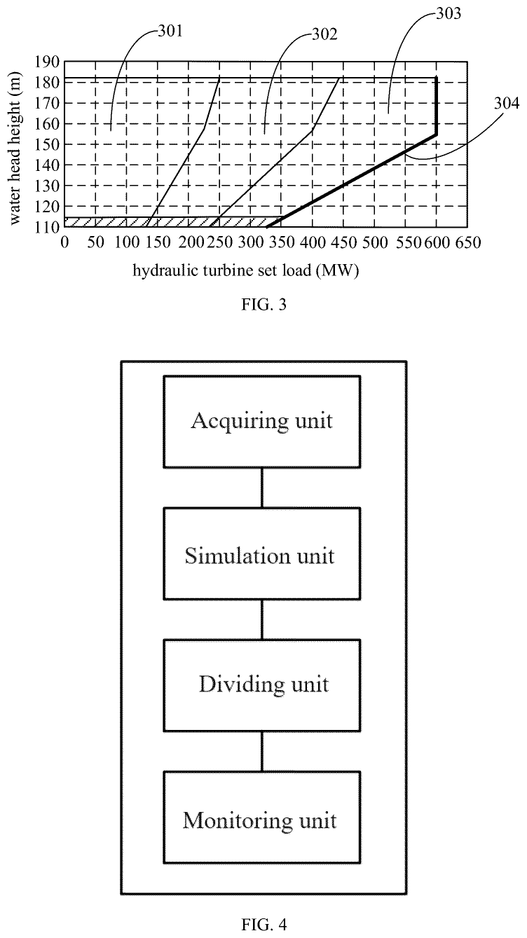

In another possible embodiment, as shown in FIG. 3, the curve is generated based on the set of the threshold values, the operating condition regions are divided into three regions (the low-efficiency operating condition region (301), the vortex band operating condition region (302), and the stable operating condition region(303)) based on the preset operating condition division parameter interval, and the output limit lines (304) of the hydraulic turbine set are all extended lines, which are preliminarily fitted in the load region in the interval of 110 m to 114.3 m (the diagonal filling section).

Step S40: determining the monitored operating condition regions of the target hydraulic turbine based on the operating limit water level and the operating condition division result, and monitoring real-time operating conditions of the target hydraulic turbine based on the monitored operating condition regions.

Specifically, determining the monitored operating condition regions of the target hydraulic turbine based on the operating limit water level and the operating condition division result includes: correcting the operating condition division result based on real hydraulic turbine test parameters or online monitoring data to obtain corrected operating condition division intervals as the monitored operating condition regions of the target hydraulic turbine.

In one possible embodiment, the operating regions are dynamically adjusted. The operating conditions of the hydraulic turbine under the extremely low water head are an emergency measure under extreme operating conditions. It is unrealistic to determine the operating regions under the water heads by a real hydraulic turbine test under all operating conditions. Therefore, in order to improve the accuracy of the load region, two methods can be adopted.

1) A real hydraulic turbine verification test. One or two typical water heads can be selected for verification. A specific method is as follows: test points are arranged according to the key operating parameters determined in the step S20, using an eddy current sensor for the hydraulic turbine guide bearing run-out, a DPS type ultra-low frequency speed sensor for the head cover vibration, and a pressure sensor for the pressure fluctuation; a hydraulic turbine is turned on with a load under a specific water head, the load is adjusted manually, selection of operating condition points is determined based on the capacity of the hydraulic turbine set, and the number of the operating condition points shall not be less than 10; the stabilization time of each operating condition point is not less than 5 min, the data acquisition time is not less than 3 min, and close attention is paid to changes in operating parameters of the hydraulic turbine set during acquisition, and if operating conditions of resonance and data surge occur, it should be comprehensively judged whether to continue operation; a maximum load point is determined by an opening limit of a guide vane opening; after data acquisition is complete, the operating regions are divided according to the health standards, as shown in FIG. 2 and FIG. 3; and comparison is made with the step S30, correction is made, and a new load operating region is fitted.

2) Online monitoring data correction. The stability parameters monitored by the online condition monitoring system are used to uninterruptedly correct the operating regions, which is suitable for other water heads except those measured. A specific method is as follows: the online condition monitoring system is checked to ensure that data is accurate and reliable, if the test points do not meet the requirements, additional test points can be added appropriately; and the stability parameters are sampled in real time during operation under other water heads; the acquired stability parameters are compared with the health standards, operating conditions corresponding to the stability parameters are roughly classified into three categories according to the conditions of the hydraulic turbine set, which are long-term operation, short-term operation and prohibited operation, respectively; if it is determined as a prohibited operating condition, a warning should be issued to remind manual intervention, if the manual intervention is not carried out, the load is automatically adjusted to that in the previous operable region after 3 min, and if there is no operable region under the water head, the hydraulic turbine is turned off; and the operation situation is marked in an operating region diagram.

Specifically, the operating condition division intervals include a prohibited operating interval, a short-term operating interval, and a long-term operating interval. The allowed operation time of the hydraulic turbine set in the short-term operating interval is a first operation time, and the allowed operation time of the hydraulic turbine set in the long-term operating interval is a second operation time, the second operation time being longer than the first operation time. Accordingly, for the step S40, monitoring the real-time operating conditions of the target hydraulic turbine based on the monitored operating condition regions includes triggering an alarm message when the hydraulic turbine set is in the prohibited operating interval, or the hydraulic turbine set is in the short-term operating interval and the operation time reaches the allowed operation time (i.e., the first operating time), or the hydraulic turbine set is in the long-term operating interval and the operation time reaches the allowed operation time (i.e., the second operating time).

In one possible embodiment, an operable water head of the hydraulic turbine can be initially expanded to a minimum water head, taking the example in the step S30 as an example, the operating water head can be increased by 4 m (114−110=4), and for a multi-year regulated reservoir, in extreme cases, the fluctuation water level can be increased by 4 m, significantly increasing the emergency reserve capacity.

Further, the extremely low water head operating regions are set into the automatic generation control (AGC) scheduling strategy of hydropower enterprises. A specific method is as follows (the following steps are in no particular order): an upstream water level is used as a trigger signal, when the actual water level is lower than the dead water level, the AGC scheduling mode under the extremely low water head is switched, and the actual water level shall not be lower than the operating limit water level Hₘᵢₙ, otherwise, the shutdown process is started; output limits are set strictly according to the water heads to prevent flow separation at an inlet of the hydraulic turbine; compared with normal AGC adjustment, a load adjustment rate should be lower than a normal rate; it is advisable to adopt a single-machine AGC operation mode to prevent large load fluctuations when the AGC of a whole plant is put into operation; and loads should be mainly with stable loads, reducing unnecessary adjustments.

Preferably, extremely low water head operation procedures for power generation enterprises are formulated. The extremely low water head operation procedures should include at least: an operating limit water level Hₘᵢₙ, load operating intervals corresponding to different water heads, an extremely low water head operation control strategy, and the like.

Preferably, an extremely low water head operation warning strategy is set. The purpose of setting an over-limit operation warning strategy is that the proposed operating regions are not real and do not cover all extremely low water head situations, and in extremely low water head regions where operation is possible, resonance, abnormal pressure fluctuation and the like may occur at any time. In order to dynamically monitor these operating conditions and prohibit the hydraulic turbine set from operating in this interval, it is necessary to carry out intelligent early warning. A specific method is as follows: operating limits are set strictly according to health standards; during the load adjustment process of the hydraulic turbine set, the warning function is in an exited state; after active power regulation exits, with a delay of 3 s, if it is detected that the operating parameters exceed the limit value twice (with an interval of greater than 0.5 s), an alarm is triggered; and after the monitoring system receives the alarm signal, if there is no human intervention, the shutdown process is started after 3 min.

By the solutions of the embodiments of the present disclosure, the gap in the division of the operating regions and the operating strategy of the hydraulic turbine under the extremely low head is filled, and the operable range of the hydraulic turbine is increased, which is conducive to improving the emergency reserve capacity of the hydraulic turbine and improving the economic benefits of hydropower enterprises.

FIG. 4 is a structural diagram of a system for a monitoring operation of a hydraulic turbine under an extremely low water head according to an embodiment of the present disclosure. As shown in FIG. 4, the system includes: an acquiring unit, configured to acquire static operating parameters of a target hydraulic turbine, and determine an operating limit water level of the target hydraulic turbine based on the static operating parameters; a simulation unit, configured to determine dynamic operating parameters of the target hydraulic turbine, and simulate operating conditions of the hydraulic turbine based on the static operating parameters and the dynamic operating parameters; a dividing unit, configured to divide operating condition regions of the hydraulic turbine based on the simulated operating conditions of the hydraulic turbine to obtain an operating condition division result; and a monitoring unit, configured to determine monitored operating condition regions of the target hydraulic turbine based on the operating limit water level and the operating condition division result, and monitor real-time operating conditions of the target hydraulic turbine based on the monitored operating condition regions.

The specific implementation details of the above units may refer to the method for monitoring operation of a hydraulic turbine under an extremely low water head, which will not be described in detail here.

An embodiment of the present disclosure also provides a computer-readable storage medium having stored thereon instructions that, when run on a computer, cause the computer to perform the method for monitoring operation of a hydraulic turbine under an extremely low water head described above.

An embodiment of the present disclosure also provides a device for monitoring operation of a hydraulic turbine under an extremely low water head, wherein the device includes: a memory storing a program capable of running on a processor; and the processor. The processor is configured to implement the following steps when executing the program: acquiring static operating parameters of a target hydraulic turbine, and determining an operating limit water level of the target hydraulic turbine based on the static operating parameters; determining dynamic operating parameters of the target hydraulic turbine, and simulating operating conditions of the hydraulic turbine based on the static operating parameters and the dynamic operating parameters; dividing operating condition regions of the hydraulic turbine based on the simulated operating conditions of the hydraulic turbine to obtain an operating condition division result; and determining monitored operating condition regions of the target hydraulic turbine based on the operating limit water level and the operating condition division result, and monitoring real-time operating conditions of the target hydraulic turbine based on the monitored operating condition regions. The details of the steps may refer to the method for monitoring operation of a hydraulic turbine under an extremely low water head, which will not be described in detail here.

Those skilled in the art will understand that implementing all or part of the steps of the method in the embodiments described above can be completed by instructing related hardware by a program, the program is stored in a storage medium and includes a plurality of instructions for causing a single chip microcomputer, a chip or a processor to execute all or part of the steps of the method according to the embodiments of the present disclosure. The aforementioned storage medium includes various media that can store program codes, such as a USB flash disk, a mobile hard disk, a Read-Only Memory (ROM), a Random Access Memory (RAM), a magnetic disk, or an optical disk.

Optional embodiments of the present disclosure are described in detail above with reference to the accompanying drawings. However, the embodiments of the present disclosure are not limited to the specific details of the embodiments described above, and many simple variations can be made to the technical solutions of the embodiments of the present disclosure within the scope of the technical idea of the embodiments of the present disclosure, and these simple variations all fall within the protection scope of the embodiments of the present disclosure. In addition, it should be noted that the specific technical features described in the above detailed description can be combined in any suitable manner without contradiction. In order to avoid unnecessary repetition, various possible combinations will not be described separately in the embodiments of the present disclosure.

In addition, any combination between various embodiments of the present disclosure may be made, as long as they do not depart from the idea of the embodiments of the present disclosure, they should also be regarded as the contents disclosed the embodiments of the present disclosure.

1. A method for monitoring operation of a hydraulic turbine under an extremely low water head, wherein the method comprises:
acquiring static operating parameters of a target hydraulic turbine, and determining an operating limit water level of the target hydraulic turbine based on the static operating parameters;
determining dynamic operating parameters of the target hydraulic turbine, and simulating operating conditions of the hydraulic turbine based on the static operating parameters and the dynamic operating parameters;
dividing operating condition regions of the hydraulic turbine based on the simulated operating conditions of the hydraulic turbine to obtain an operating condition division result; and
determining monitored operating condition regions of the target hydraulic turbine based on the operating limit water level and the operating condition division result, and monitoring real-time operating conditions of the target hydraulic turbine based on the monitored operating condition regions.

2. The method according to claim 1, wherein the static operating parameters comprise:
one or more of a hydraulic turbine set type, a reservoir dead water level, a water inlet layout elevation, a normal tail water level, a hydraulic turbine operating performance curve, hydraulic turbine model test data, hydraulic turbine set online monitoring data, a water supply mode, a gate hole height, a cross-section average flow rate in a gate hole, and a water inlet top elevation.

3. The method according to claim 1, wherein determining the operating limit water level of the target hydraulic turbine based on the static operating parameters comprises:
calculating a minimum submersion depth based on the static operating parameters and a preset first calculation model; and
calculating the operating limit water level based on the minimum submersion depth and a preset second calculation model.

4. The method according to claim 3, wherein the first calculation model is:
S=Cvd^{0.5}
wherein S is the minimum submersion depth, C is a preset factor, v is a cross-section average flow rate in a gate hole, and dis a gate hole height;
wherein the second calculation model is:
$${H}_{min} = {H}_{d} + S$$
wherein H_{d} is a water inlet top elevation, and Hₘᵢₙ is the operating limit water level.

5. The method according to claim 1, wherein the dynamic operating parameters comprise:
one or more of pressure fluctuation in a draft tube, pressure fluctuation in a bladeless region, head cover vibration, and a hydraulic turbine guide bearing run-out.

6. The method according to claim 1, wherein simulating the operating conditions of the hydraulic turbine based on the static operating parameters and the dynamic operating parameters comprises:
traversing all water heads, and simulating the operating conditions of the hydraulic turbine based on an electrical measurement method under the water heads;
separately collecting operating parameters of the hydraulic turbine corresponding to simulation results under the water heads as simulation parameters; and
integrating the simulation parameters under all water heads to form a simulation parameter set.

7. The method according to claim 6, wherein dividing the operating condition regions of the hydraulic turbine based on the simulated operating conditions of the hydraulic turbine comprises:
constructing a two-dimensional coordinate system with a hydraulic turbine set load as an abscissa and a water head height as an ordinate;
generating a curve in the two-dimensional coordinate system based on the simulation parameter set; and
dividing the operating condition regions based on a preset operating condition division parameter interval for the generated curve;
wherein the operating condition regions comprise a low-efficiency operating condition region, a vortex band operating condition region, and a stable operating condition region.

8. The method according to claim 1, wherein simulating the operating conditions of the hydraulic turbine based on the static operating parameters and the dynamic operating parameters comprises:
collecting standard information for hydraulic turbine operation based on an open standard knowledge base;
traversing preset operating conditions, and determining threshold values of the parameters based on the standard information for hydraulic turbine operation; and
obtaining a set of the threshold values based on all the threshold values.

9. The method according to claim 8, wherein dividing the operating condition regions of the hydraulic turbine based on the simulated operating conditions of the hydraulic turbine comprises:
constructing a two-dimensional coordinate system with a hydraulic turbine set load as an abscissa and a water head height as an ordinate;
generating a curve in the two-dimensional coordinate system based on the set of the threshold values; and
dividing the operating condition regions based on a preset operating condition division parameter interval for the generated curve;
wherein the operating condition regions comprise a low-efficiency operating condition region, a vortex band operating condition region, and a stable operating condition region.

10. The method according to claim 1, wherein determining the monitored operating condition regions of the target hydraulic turbine based on the operating limit water level and the operating condition division result comprises:
correcting the operating condition division result based on real hydraulic turbine test parameters or online monitoring data to obtain corrected operating condition division intervals as the monitored operating condition regions of the target hydraulic turbine;
wherein the operating condition division intervals comprise a prohibited operating interval, a short-term operating interval, and a long-term operating interval, wherein the allowed operation time of a hydraulic turbine set in the long-term operating interval is longer than that in the short-term operating interval.

11. The method according to claim 10, wherein monitoring the real-time operating conditions of the target hydraulic turbine based on the monitored operating condition regions comprises:
triggering an alarm message when the hydraulic turbine set is in the prohibited operating interval, or the hydraulic turbine set is in the short-term operating interval and the operation time reaches the allowed operation time, or the hydraulic turbine set is in the long-term operating interval and the operation time reaches the allowed operation time.

12. A system for monitoring operation of a hydraulic turbine under an extremely low water head, wherein the system comprises:
an acquiring unit, configured to acquire static operating parameters of a target hydraulic turbine, and determine an operating limit water level of the target hydraulic turbine based on the static operating parameters;
a simulation unit, configured to determine dynamic operating parameters of the target hydraulic turbine, and simulate operating conditions of the hydraulic turbine based on the static operating parameters and the dynamic operating parameters;
a dividing unit, configured to divide operating condition regions of the hydraulic turbine based on the simulated operating conditions of the hydraulic turbine to obtain an operating condition division result; and
a monitoring unit, configured to determine monitored operating condition regions of the target hydraulic turbine based on the operating limit water level and the operating condition division result, and monitor real-time operating conditions of the target hydraulic turbine based on the monitored operating condition regions.

13. A system for monitoring operation of a hydraulic turbine under an extremely low water head, wherein the system comprises:
a memory storing a program capable of running on a processor; and
the processor configured to implement the following steps when executing the program:
acquiring static operating parameters of a target hydraulic turbine, and determining an operating limit water level of the target hydraulic turbine based on the static operating parameters;
determining dynamic operating parameters of the target hydraulic turbine, and simulating operating conditions of the hydraulic turbine based on the static operating parameters and the dynamic operating parameters;
dividing operating condition regions of the hydraulic turbine based on the simulated operating conditions of the hydraulic turbine to obtain an operating condition division result; and
determining monitored operating condition regions of the target hydraulic turbine based on the operating limit water level and the operating condition division result, and monitoring real-time operating conditions of the target hydraulic turbine based on the monitored operating condition regions.

14. The system according to claim 13, wherein the processor is configured to determine the operating limit water level of the target hydraulic turbine based on the static operating parameters, comprising:
calculating a minimum submersion depth based on the static operating parameters and a preset first calculation model; and
calculating the operating limit water level based on the minimum submersion depth and a preset second calculation model.

15. The system according to claim 14, wherein the first calculation model is:
S=Cvd^{0.5}
wherein S is the minimum submersion depth, C is a preset factor, v is a cross-section average flow rate in a gate hole, and dis a gate hole height;
wherein the second calculation model is:
$${H}_{min} = {H}_{d} + S$$
wherein H_{d} is a water inlet top elevation, and Hₘᵢₙ is the operating limit water level.

16. The system according to claim 13, wherein the processor is configured to simulate the operating conditions of the hydraulic turbine based on the static operating parameters and the dynamic operating parameters, comprising:
traversing all water heads, and simulating the operating conditions of the hydraulic turbine based on an electrical measurement method under the water heads;
separately collecting operating parameters of the hydraulic turbine corresponding to simulation results under the water heads as simulation parameters; and
integrating the simulation parameters under all water heads to form a simulation parameter set.

17. The system according to claim 13, wherein the processor is configured to simulate the operating conditions of the hydraulic turbine based on the static operating parameters and the dynamic operating parameters, comprising:
collecting standard information for hydraulic turbine operation based on an open standard knowledge base;
traversing preset operating conditions, and determining threshold values of the parameters based on the standard information for hydraulic turbine operation; and
obtaining a set of the threshold values based on all the threshold values.

18. The system according to claim 13, wherein the processor is configured to determine the monitored operating condition regions of the target hydraulic turbine based on the operating limit water level and the operating condition division result, comprising:
correcting the operating condition division result based on real hydraulic turbine test parameters or online monitoring data to obtain corrected operating condition division intervals as the monitored operating condition regions of the target hydraulic turbine;
wherein the operating condition division intervals comprise a prohibited operating interval, a short-term operating interval, and a long-term operating interval, wherein the allowed operation time of a hydraulic turbine set in the long-term operating interval is longer than that in the short-term operating interval.

19. The system according to claim 18, wherein the processor is configured to monitor the real-time operating conditions of the target hydraulic turbine based on the monitored operating condition regions, comprising:
triggering an alarm message when the hydraulic turbine set is in the prohibited operating interval, or the hydraulic turbine set is in the short-term operating interval and the operation time reaches the allowed operation time, or the hydraulic turbine set is in the long-term operating interval and the operation time reaches the allowed operation time.
